(19) United States
(12) Patent Application Publication
(10) Pub. No.: US 2006/0088145 A1
(43) Pub. Date: Apr. 27, 2006

(54) Methods and systems for an interactive communications directory and directory channel

(75) Inventors: James Keith Reed, Marietta, GA (US); John Pumpelly, Atlanta, GA (US)

Correspondence Address: BAMBI FAIVRE WALTERS, PO BOX 5743, WILLIAMSBURG, VA, 23188, US

(73) Assignee: BellSouth Intellectual Property Corporation

(21) Appl. No.: 10/974,499

(22) Filed: Oct. 27, 2004

(51) Int. Cl. H04M 1/64; H04M 3/42

(52) U.S. Cl. 379/88.19; 379/218.01; 455/417

(57) ABSTRACT

A user may use an input terminal, a remote control device, and/or an alternate device to select an electronic communications directory to access, or alternatively, to download and store to memory of a media delivery device. A directory assist and connect module includes instructions and/or commands that enable the user to access, enter, modify, forward, and/or select a directory listing to establish a communications link. For example, the user may select a directory listing from a White Pages directory and/or a Yellow Pages directory provided by a local service provider and input instructions to establish a communications connection with the selected directory listing from the media delivery device or via a communications device communicating with the media delivery device.

### CROSS REFERENCE TO RELATED APPLICATION

This application relates to applicants' co-pending application entitled “Methods And Systems For Delivering Yellow Pages Content To A Media Delivery Device,” (Attorney Docket BS030796) filed simultaneously herewith, and of which the “Brief Summary of the Invention” and “Detailed Description of the Invention” sections are incorporated herein by this reference.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND

The exemplary embodiments generally relate to media delivery, storage, and communications systems and, more particularly, to systems and methods for an interactive communications directory to establish a communications connection with a directory listing.

Consumers typically maintain or have access to a variety of communications directories that include names, telephone numbers, geographical addresses, electronic communications addresses (e.g., email, web page, and so on), and more. For example, the consumer may have a telephone directory provided by a local service provider (e.g., BellSouth's Yellow Pages for a geographic area), a personal telephone directory (e.g., telephone numbers, email addresses, home addresses, birthdays, and other information for relatives and friends), a neighborhood directory (e.g., a listing of names, telephone numbers, addresses, and other information (e.g., position in homeowners' organization, babysitting services, pet sitting services, and so on) of property owners in a development), and other clubs and/or organizational directories (e.g., a directory of names, addresses, telephone numbers, electronic communications addresses, and other information of church members, school and/or class members, and other clubs and organizations). Some of the directory information may be stored in hard copy form, such as a handwritten directory, a directory provided to a consumer by a service provider (e.g., the Yellow Pages), a directory provided to a member from a club and/or organization, and some may be stored in electronic format (e.g., an electronic address book, a web page with directory information, and so on).

Locating a communications directory presents challenges when more than one user has access to the directory, when a user misplaces or loses the directory, and/or when a user does not actually possess the directory, but wishes to have access to the directory. And even after the user locates the directory, the user may have difficulty searching for a directory listing, such as the user trying to appropriately identify a category of providers for goods and/or services, to search for a listing in a particular geographic area, to figure out an appropriate spelling of an individual and/or business name, to easily handle a directory due to its size and/or condition (e.g., falling apart), and/or to read the directory (e.g., size of typewritten font or handwriting may be difficult to read). And, if a listing is non-published, then the directory does not contain the listing, even to identify a name of the individual or business. Further, printed directories, such as a Yellow Pages directory, may be costly to produce and/or to distribute for the provider, and consequently, the printed directory may have a limited publication and/or distribution (e.g., published once per year or other lengthy time period, distribution to a certain locations and/or hubs, and/or other limitations). Consequently, the provider directory often does not include up to date of directory listings of new listings or modifications to other listings. Still further, an advertiser may find it prohibitively expensive and/or untimely to advertise in a provider directory because the provider directory may only be occasionally produced.

Many consumers own a television (“TV”). And, in the TV industry (e.g., satellite broadcast, digital cable, telephony and more), service providers and manufacturers have started to introduce home communications terminals known as set top boxes (STBs) that may be Web-enabled and that may include computer hard drives for recording, storing, and/or playing broadcast and other media content. In addition to supporting traditional analog broadcast, many digital STBs are enhanced so that the STB can present one program while recording another program and/or so that the consumer can engage in two-way communications, such as, for example, video/audio on demand (VOD), interactive TV, Web surfing, e-mail, electronic shopping, and recording/storing/playback of broadcast programs. Many of these available services are media intensive and demand high bandwidth. And, even when media content is stored to the hard drive of an enhanced STB, the consumer has little control of organizing, modifying, and/or integrating content of the media with other stored media content (e.g., cutting and pasting from one media content into another media content to create and store an integrated file).

In view of the foregoing, it can be appreciated that a need exists for systems and methods that advantageously provide directory content. More particularly, a need exists for systems and methods that leverage assets of the consumer to provide comprehensive directory services.

### SUMMARY

The aforementioned problems, and other problems, are reduced by methods, systems, computer programs, and/or computer program products that provide comprehensive directory services to a media delivery device. These comprehensive directory services enable a communications connection with a selected directory listing. The exemplary embodiments, in particular, provide a directory channel that is broadcast to or otherwise communicated to a media delivery device for storage and/or integration with other directory content, for presentment to an audio/video (AV) device, and for establishing a communications connection with a communications address of a selected directory listing. The media delivery device and the AV device may be integrated into a single device, or, alternatively, the two devices may be stand-alone devices such as a set-top box (STB) coupled or otherwise connected with a television, a computer, and/or a digital television. According to some of the embodiments, a user may tune in the directory channel to view, download, search, and/or otherwise access an electronic communications directory. The electronic communications directory may include one or more directory listings of names, communications addresses, physical addresses, categories of goods and/or services, and/or other information. And because this invention stores a selected electronic communications directory to the local memory device, the user may access the directory even when the broadcast signal (or, alternate media delivery signal) is impaired. According to further exemplary embodiments, the electronic communications directory may include an associated file such as an advertisement and/or other marketing information. And, still further exemplary embodiments provide a directory assist and connect module executing instructions and/or commands that enable a user to access, enter, modify, and/or establish a communications connection with a directory listing of the electronic communications directory and to select an alternate communications device to establish the communications link with the directory listing.

In an exemplary embodiment, a media delivery device an electronic communications directory stored in a memory device and a directory assist and connect module for accessing and selecting a directory listing of the electronic communications directory and for establishing a communications connection with the selected directory listing. The electronic communications directory includes a directory listing that includes a directory name with a communications address and may also include additional information with the directory name, such as, for example, a physical address, an identification category (e.g., a Yellow Pages category for a business listing, a personal category created by the consumer such as “January Birthdays” for a listing of an individual with a January birthday, a type of communications address such as a “mobile telephone number,” and so on), and a graphic (such as a logo, a map, and/or directions). The directory assist and connect module may store the directory listing and/or a selection of one or more communications devices (e.g., the media delivery device, a cell phone, a computer, and others communications devices that are capable of communicating with the media delivery device) to establish the communications connection with the communications address of the directory listing for a future search and/or to otherwise manage a profile of the directory listing. For example, the directory assist and connect module may establish a communications connection with the communications address of the selected directory listing and link in another communications device, such as a cellular phone communicating with a wireless transceiver of the media delivery device such that the user may use the cellular phone to communicate with the connected communications address. Alternatively, the directory assist and connect module may communicate the communications address of the selected directory listing to the cellular phone, and a user may use the cellular service provider's communications network to establish the communications with the selected directory listing.

According to another exemplary embodiment, a method of assisting with and connecting to a selected directory listing of an electronic communications directory includes accessing an electronic communications directory of a media delivery device, selecting a directory listing, and initiating a communications signal to establish a communications connection with the communications address of the selected directory listing. Some of the alternate embodiments include communicating the communications address of the selected directory listing to a communications device and having the communications device establish a communications connection with the communications address of the selected directory listing. To initiate the communications connection, a user may select the directory listing and a menu option to establish the communications connection by actuating a pushbutton key on a wireless device (e.g., a remote control, a wireless communications device, and others) operable to transmit and receive an encoded signal with the media delivery device and/or with an integrated device (e.g., an input terminal such as a keypad) of the media delivery device. The communications address may be an electronic data communications address, such as an email address, webpage, and/or an Internet Protocol (IP) associated address, and/or may be a telecommunications address, such as a telephone number or a communications address utilizing any frequency in the electromagnetic spectrum (e.g., short wave radio receiver). Further embodiments include selecting a second directory listing and establishing a communications link among the first directory listing, the second directory listing, and the communications device interfacing with the media delivery device (or, alternatively the media delivery device). Still further embodiments include inserting an audio/visual cue into the electronic communications directory to prompt the user for a response during presentment of the selected directory listing or during establishment of the communications connection. If the user responds to the audio/visual cue, then the response may be communicated to an external network. If, however, the user does not respond to the audio/visual cue, then presentment of the cue discontinues.

According to yet another exemplary embodiment, a computer program product includes instructions for accessing an electronic communications directory of a media delivery device, selecting a directory listing, and initiating a communications signal to establish a communications connection with the communications address of the selected directory listing. Some other embodiments include the computer program product with instructions for communicating the communications address of the selected directory listing to a communications device and having the communications device establish a communications connection with the communications address of the selected directory listing. Further embodiments include the computer program product with instructions for selecting a second directory listing and establishing a communications link among the first directory listing, the second directory listing, and the communications device interfacing with the media delivery device (or, alternatively the media delivery device).

Other systems, methods, and/or computer program products according to embodiments will be or become apparent to one with skill in the art upon review of the following drawings and detailed description. It is intended that all such additional systems, methods, and/or computer program products be included within and protected by this description and be within the scope of the present invention.

### DESCRIPTION OF THE DRAWINGS

The above and other embodiments, objects, uses, advantages, and novel features are more clearly understood by reference to the following description taken in connection with the accompanying figures, wherein:

FIG. 1 illustrates a block diagram of exemplary details of a media delivery device according to some of the exemplary embodiments;

FIG. 2 is a simplified schematic of an operating environment according to some of the exemplary embodiments;

FIG. 3 is a schematic of another operating environment according to some of the exemplary embodiments;

FIG. 4 depicts a schematic of an exemplary operating environment according to some of the exemplary embodiments;

FIG. 5 illustrates a schematic of another exemplary operating environment according to some of the exemplary embodiments;

FIG. 6 is a schematic of still another exemplary operating environment according to some of the exemplary embodiments;

FIG. 7 depicts an alternate block diagram of exemplary details of another media delivery device according to some of the exemplary embodiments; and

FIGS. 8 and 9 are flowcharts illustrating a method of providing assistance with and connection to a selected directory listing of a media delivery device according to some of the exemplary embodiments.

### DESCRIPTION

The exemplary embodiments now will be described more fully hereinafter with reference to the accompanying drawings, in which exemplary embodiments are shown. The exemplary embodiments may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, flowcharts, illustrations, and the like represent conceptual views or processes illustrating systems, methods and computer program products embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

The exemplary embodiments include methods, systems, computer programs, and/or computer program products that provide comprehensive directory services to a media delivery device and that enable a communications connection with a selected directory listing. According to some of the embodiments, a directory channel broadcasts or otherwise communicates an electronic communications directory (also referred to herein as “directory”) with a media delivery device for storage and/or integration with other directory content, for presentment to an audio/video (AV) device, and/or for establishing a communications connection with a communications address of a selected directory listing. For example, a service provider such as a telecommunications provider (e.g., BellSouth) and/or a data service provider (e.g., America Online (AOL)) may broadcast or otherwise communicate the directory of communications listings and/or other media content via the directory channel. Similarly local clubs, organizations, and/or facilities (e.g., a church, a homeowners' association, a school, a soccer club, and/or others) may provide a customized electronic communications directory of listings tailored for members and/or non-members to the directory channel. Regardless of the provider for the directory, the directory is communicated to the media delivery device for presentment to the user (also referred to herein as the “consumer,” “viewer,” and/or “customer”). The media delivery device may include an integrated AV device, or alternatively, the media delivery device and the AV device may be stand-alone devices such as an STB coupled or otherwise connected with a TV.

According to some of the embodiments, the user may tune in the directory channel to view the broadcast of one or more electronic communications directories. The user may use an input terminal, a remote control device, and/or an alternate device to select a directory to access, or alternatively, to download and store to memory of the media delivery device, such as to the hard drive of an STB. For example, according to one of the exemplary embodiment, furniture (e.g., a couch, a chair, a table, and other furniture) having an integrated input terminal, control panel, and/or communications interface with the media delivery device is used to select the directory to access, download, store, and/or otherwise manage. According to additional embodiment, the electronic communications directory may include one or more listings of names, communications addresses, physical addresses, categories of goods and/or services, and/or other associated information. A directory assist and connect module of the memory device includes instructions and/or commands that enable the user to access, enter, modify, and/or select a directory listing to establish a communications link. For example, the user may select a directory listing from a White Pages directory and/or a Yellow Pages directory provided by a local service provider and input instructions to establish a communications connection with the selected directory listing from the media delivery device or via a communications device communicating with the media delivery device. To initiate the communications connection, a user may select the directory listing and a menu option to establish the communications connection by actuating a pushbutton key on a wireless device (e.g., a remote control, a wireless communications device, and others) operable to transmit and receive an encoded signal with the media delivery device and/or with an integrated device (e.g., an input terminal such as a keypad) of the media delivery device. The communications address may be an electronic data communications address, such as an email address, webpage, and/or an Internet Protocol (IP) associated address, and/or may be a telecommunications address, such as a telephone number or a communications address utilizing any frequency in the electromagnetic spectrum (e.g., short wave radio receiver).

As used herein, the term “directory listing” includes a name of an individual and/or a business, a listing of a category and/or services, a physical address, a telecommunications address (e.g., a telephone number), an electronic communications address (e.g., an email address), and/or other associated information (e.g., personalized information of an individual such as a birthday, helpful information for a business such as hours of operation, acceptable means of payment, a map within a proximate area of the listed business address, and incentives and/or other promotional material, and/or helpful information for a club and/or organization such as a calling tree for passing messages, identification of officers with responsibilities, and other helpful information). A customer of this directory service may access any electronic directory that is locally stored at the customer's premise. This directory service, however, also provides for interactive communications with a remote directory server. Using this service the customer may download a selected directory, a media file, and/or associated information via a broadband terrestrial communications link, such as a digital subscriber line (DSL), a coaxial cable, and/or a fiber optic line. Alternate communications links, such as a wireless communications link may be used to communicate the selected directory, media file, and/or associated information to the media delivery device. Further, as used to describe some of the embodiments, the term “electronic communications directory” encompasses video, audio, audio-video, text, graphics, facsimile, data, animation, and combinations thereof.

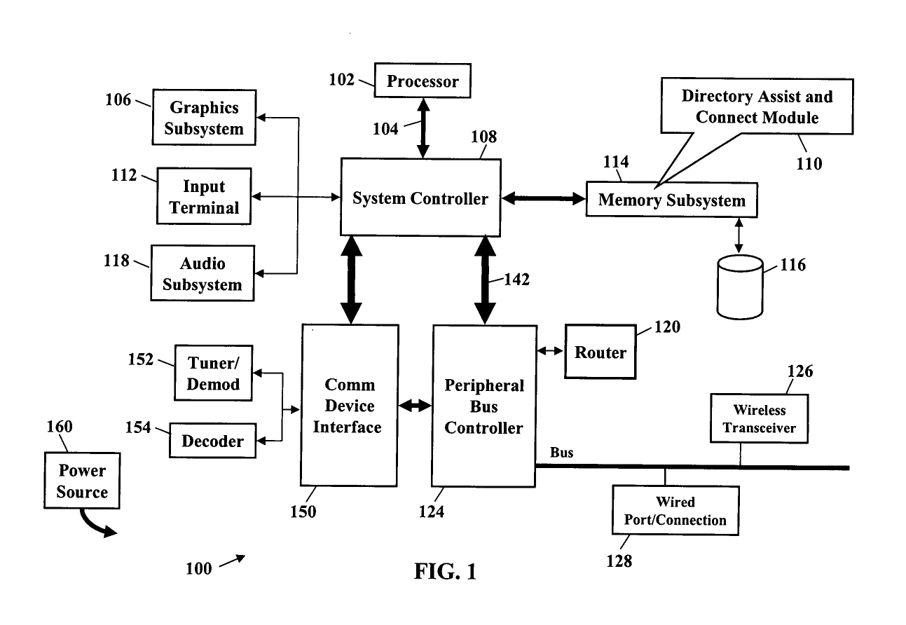

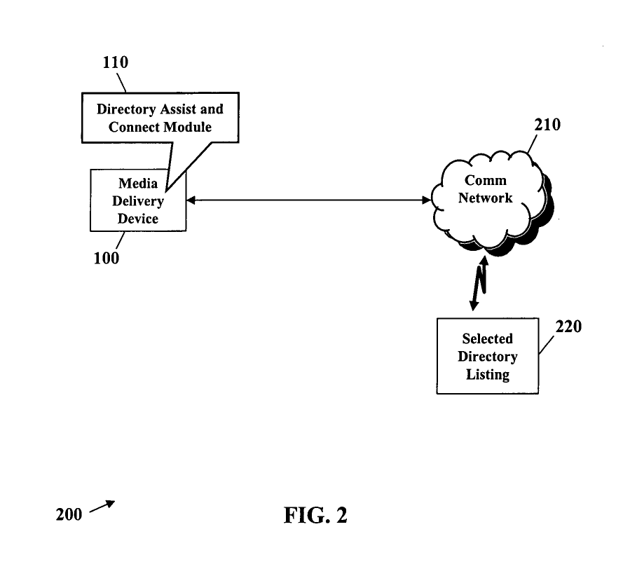

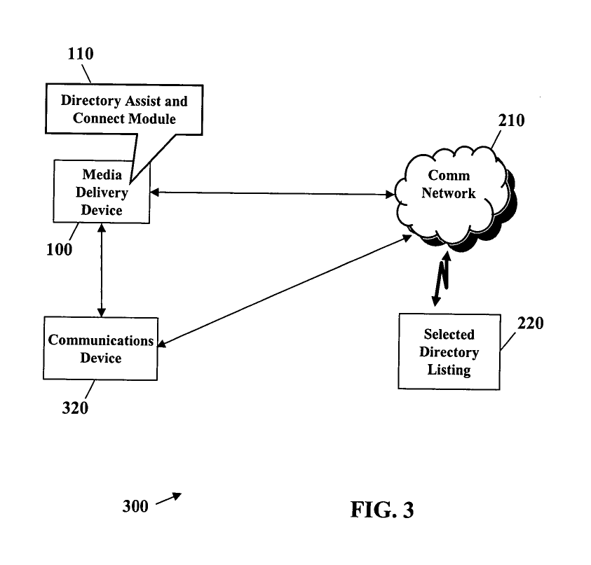

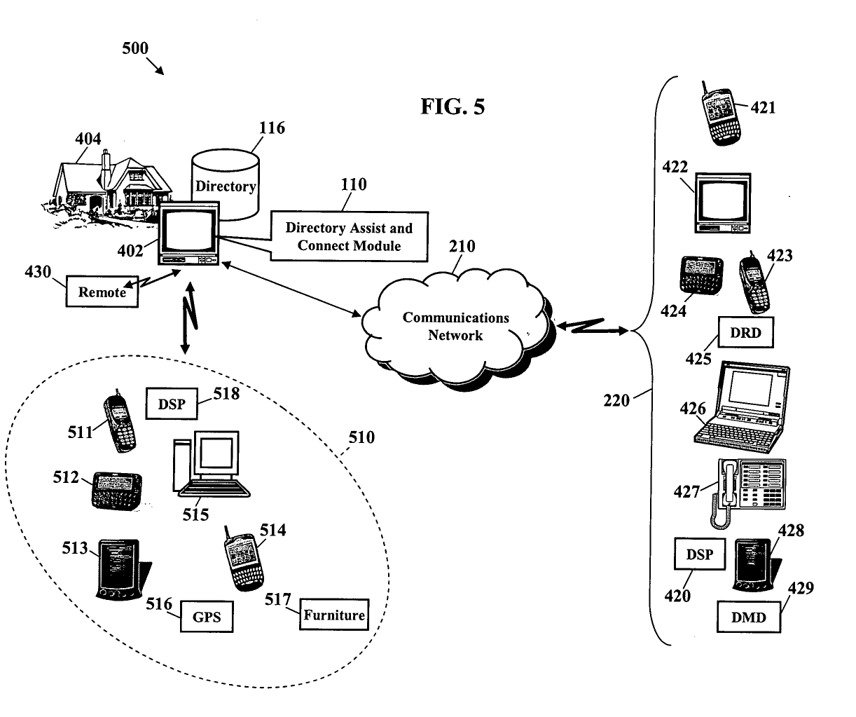

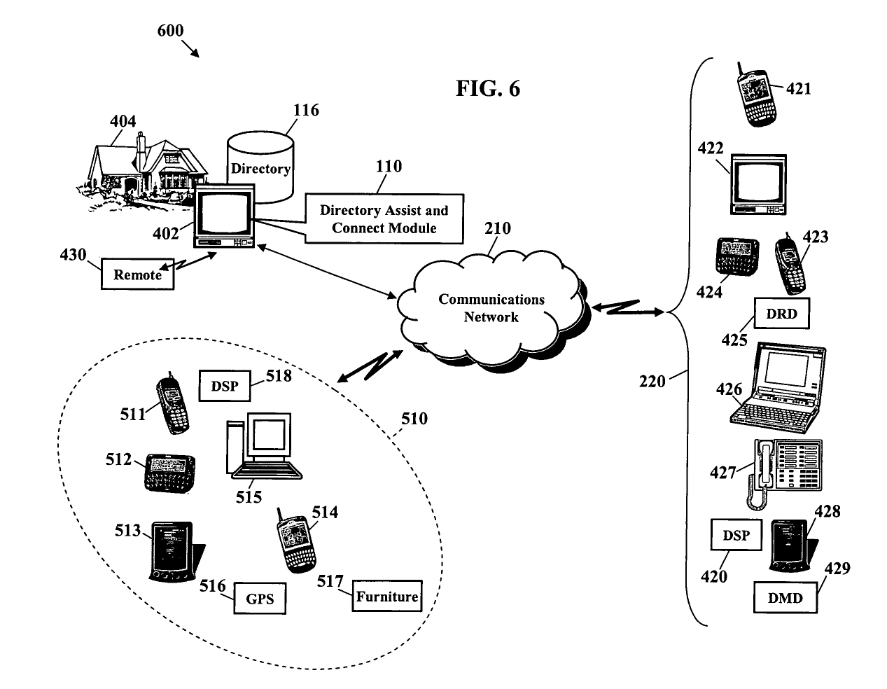

Referring now to the figures, FIG. 1 is a block diagram showing a directory assist and connect module 110 residing in a computer system shown as a media delivery device 100. As FIG. 1 shows, the directory assist and connect module 110 operates within a system memory device. The directory assist and connect module 110, for example, is shown residing in a memory subsystem 114. The directory assist and connect module 110, however, could also reside in flash memory or a peripheral storage device 116. The media delivery device 100 also has one or more central processors 102 executing an operating system. The operating system, as is well known in the art, has a set of instructions that control the internal functions of the media delivery device 100, and furthermore has the capability to communicate a communications signal among the media delivery device 100, a communications network (e.g., reference numeral 210 in FIGS. 2-3), and/or a connected electronic device capable of communicating audio, graphical, and/or other sensory data (e.g., a TV connected with the media delivery device 100, a wireless transceiver in an electronic device such as a remote control device, an appliance, a communications device (e.g., communications devices shown as reference numeral 510 in FIGS. 5-6), and/or other devices).

The system controller 108 provides a bridging function between the one or more central processors 102, a video/graphics subsystem 106, an input terminal 112, and an audio subsystem 118, the memory subsystem 114, a PCI (Peripheral Controller Interface) bus, and a Communications (“Comm”) Device Interface 150. The PCI bus is controlled by a Peripheral Bus Controller 124. The Peripheral Bus Controller 124 (typically called a “Southbridge”) is an integrated circuit that serves as an input/output hub for various peripheral ports and/or transceivers. The Peripheral Bus Controller 124 allows for communications with the communications network and any connected electronic device. The peripheral ports allow the media delivery device 100 to communicate with a variety of devices through networking ports (such as SCSI or Ethernet, not shown) and/or transceivers that include Wireless Communications (“Comm”) Device Transceiver 126 (for communication of any frequency signal in the electromagnetic spectrum, such as, for example, the 802 family of standards and Infrared) and Wired Communications (“Comm”) Device Port/Connection 124 (such as modem V90+ and compact flash slots). These peripheral ports could also include other networking ports, such as, a serial port (not shown) and/or a parallel port (not shown). Further, a tuner/demodulator 152 may receive encoded digital signals (e.g., signals from a satellite receiver, a cable feed, and so on). The digital signals are divided into audio and video signals. The tuner/demodulator 152 tunes to the frequency of a broadcast media stream that is selected by the user. The tuner/demodulator 152 feeds the digital signals into a decoder 154 (either directly or via the Communications Device Interface 150). The tuner/demodulator tunes to the frequency of a selected decoder transport stream that is then decoded and fed to the graphics and audio subsystems 106, 118, such as A/V out jacks to a TV. Further, the media delivery device 100 may include a power source 160, such as a rechargeable battery to provide power and allow the media deliver device 100 to be portable. Additionally, those of ordinary skill in the art understand that the program, processes, methods, and systems described in this patent are not limited to any particular computer system or computer hardware.

Those of ordinary skill in the art also understand the central processor 102 is typically a microprocessor. Advanced Micro Devices, Inc., for example, manufactures a full line of ATHLON™ microprocessors (ATHLON™ is a trademark of Advanced Micro Devices, Inc., One AMD Place, P.O. Box 3453, Sunnyvale, Calif. 94088-3453, 408.732.2400, 800.538.8450, www.amd.com). The Intel Corporation also manufactures a family of X86 and P86 microprocessors (Intel Corporation, 2200 Mission College Blvd., Santa Clara, Calif. 95052-8119, 408.765.8080, www.intel.com). Other manufacturers also offer microprocessors. Such other manufacturers include Motorola, Inc. (1303 East Algonquin Road, P.O. Box A3309 Schaumburg, Ill. 60196, www.Motorola.com), International Business Machines Corp. (New Orchard Road, Armonk, N.Y. 10504, (914) 499-1900, www.ibm.com), and Transmeta Corp. (3940 Freedom Circle, Santa Clara, Calif. 95054, www.transmeta.com). Those skilled in the art further understand that the program, processes, methods, and systems described in this patent are not limited to any particular central processor of a manufacturer.

The operating system may be a UNIX® operating system (UNIX® is a registered trademark of the Open Source Group, www.opensource.org). Other UNIX-based operating systems, however, are also suitable, such as LINUX) or a RED HAT® LINUX-based system (LINUX® is a registered trademark of Linus Torvalds, and RED HAT® is a registered trademark of Red Hat, Inc., Research Triangle Park, N.C. 1-888-733-4281, www.redhat.com). Other operating systems, however, are also suitable. Such other operating systems may include a WINDOWS-based operating system (WINDOWS® is a registered trademark of Microsoft Corporation, One Microsoft Way, Redmond Wash. 98052-6399, 425.882.8080, www.Microsoft.com) and Mac® OS (Mac® is a registered trademark of Apple Computer, Inc., 1 Infinite Loop, Cupertino, Calif. 95014, 408.996.1010, www.apple.com). Those of ordinary skill in the art again understand that the program, processes, methods, and systems described in this patent are not limited to any particular operating system.

According to an embodiment, the memory subsystem 114 operates with the processor 102 to maintain a list of television stations (or other multimedia delivery mediums) that are available to the viewer in accordance with a subscription plan. In order to select a channel, the processor 102 either receives signals from the input terminal 112, the wireless transceiver 126, and/or a device coupled or otherwise connected with the wired/wireless port/connection 128. Alternatively, the memory subsystem (shown as memory subsystem 114 and/or peripheral storage device 116) may store one or more local electronic communications directories that the user may access to select a directory listing. Further, the system memory device may also contain an application program that cooperates with the operating system and with other input/output devices (e.g., the graphics subsystem 106, the input terminal 112, and/or the audio subsystem 118) to provide a graphical user interface (GUI). The graphical user interface provides a convenient visual and/or audible interface with the media delivery device 100. For example, a directory assist and connect module 110 provides a GUI that enables the user to access, select, modify, and/or distribute a directory listing (and/or electronic communications directory) and to establish a communications connection with the selected directory listing.

As shown in FIG. 2, a directory assist and connect operating environment 200 includes a communications connection among the media delivery device 100 having the directory assist and connect module 110 and a communications address of the selected directory listing 220 via a communications network 210. Further, FIG. 3 illustrates another directory assist and connect operating environment 300 that includes a communications connection among the media delivery device 100 having the directory assist and connect module 110, a communications device 320, and the selected directory listing 220 via the communications network 210. That is according to the exemplary embodiments of FIG. 2, the directory assist and connect module 110 establishes the communications connection among the media delivery device 100 and the selected directory listing 220. And, according to the exemplary embodiments of FIG. 3, the directory assist and connect module 110 established the communications connection among the communications device 320 and the selected directory listing 220 via the communications network 210, or, alternatively via the media device 100 and the communications network 210. For example, the directory assist and connect module 110 may interact with a directory-on-demand service (or an alternate source that provides the electronic communications directory) via a web browser or alternate interface to present a menu on a display device of the media delivery device 100. If the directory assist and connect module 110 uses the web browser, then an application server may respond to Hyper-Text Transfer Protocol (HTTP) requests by processing the requested URL and parameters according to the service it is providing. This may require accessing and/or storing data (e.g., the electronics communications directory) in a server database. According to an exemplary embodiment, the directory-on-demand service stores the electronics communications directory and related information as Extensible Style Sheet (XSL) documents that allow the XML directory-on-demand information to be translated into HTML using an XSL processor. The server application (within the communications network) then translates the XML data into HTML data and transmits it to the web browser that presents the HTML data of the electronics communications directory to the display device, such as a computer monitor or a television screen. The information presented, for example, may include information about electronic communications directories (including updated directories for a supplemental download), maps, appointment scheduling, advertisements, and/or other related information that is available via the directory-on-demand service. According to another exemplary embodiment, Real Simple Syndication (RSS) that uses XML structures may be similarly used to feed electronic communications directories and related information from a source (e.g., the directory-on-demand service provider in the communications network 210) to a destination (e.g., the media delivery device 100).

The media delivery device 100 can be any device, such as an analog/digital recorder, television, CD/DVD player/recorder, audio equipment, receiver, tuner, and/or any other consumer media delivery device 100. The media delivery device 100 may also include any computer, peripheral device, camera, modem, storage device, telephone, personal digital assistant, and/or mobile phone. The communications network 210 may be a television/cable network operating in the radio-frequency domain and/or the Internet Protocol (IP) domain. The communications network 210, however, may also include a distributed computing network, such as the Internet (sometimes alternatively known as the “World Wide Web”), an intranet, a satellite network, a telecommunications network (e.g., Public Switched Telephone Network, Mobile Switching Telephone Office, and others), a local-area network (LAN), and/or a wide-area network (WAN). The communications network 210 may include coaxial cables, copper wires, fiber optic lines, and/or hybrid-coaxial lines. The communications network 210 may even include wireless portions utilizing any portion of the electromagnetic spectrum and any signaling standard (such as the I.E.E.E. 802 family of standards). The communications address may be an electronic data communications address, such as an email address, webpage, and/or an Internet Protocol (IP) associated address, and/or may be a telecommunications address, such as a telephone number or a communications address utilizing any frequency in the electromagnetic spectrum (e.g., short wave radio receiver).

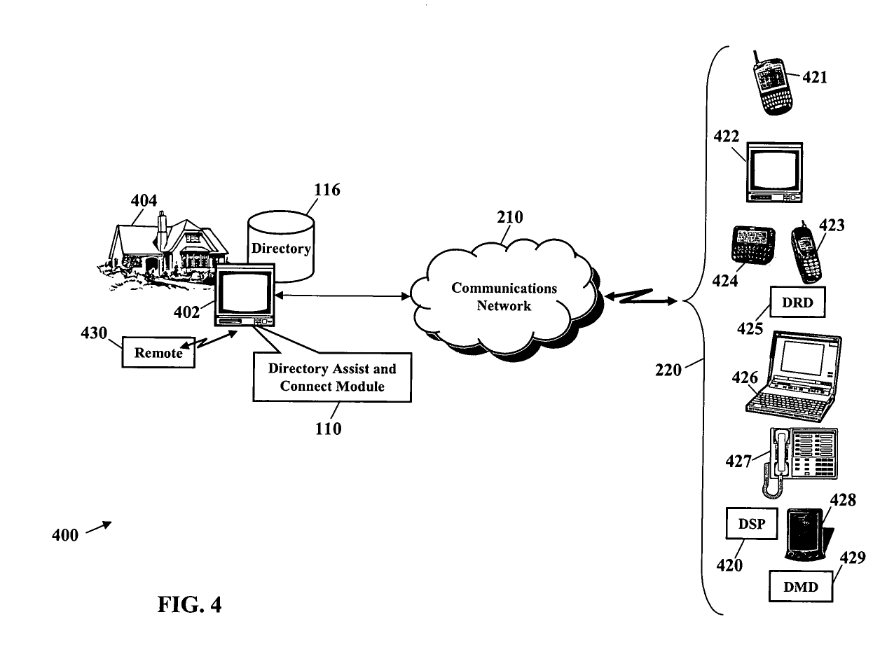

FIG. 4 illustrates an exemplary embodiment of a directory assist and connect operating environment 400 that includes a residence 302 with a media delivery device shown as an integrated set top box and television 302 having the directory assist and connect module 110 and the electronic communications directory stored in database 116, a remote control device 330, a communications network 310, and various communications devices of the selected directory listing 220. These various communications device may include a Voice over Internet Protocol (VoIP) phone 421, an interactive TV 422, a cellular phone 423, an interactive pager 424, a digital recording device (DRD) 425, a computer 426, a plain old telephone (POTS) phone 427, a personal digital assistant 428, and/or any communications device having a digital signal processor (DSP) 229.

Typically, the user initiates a communications session from the multimedia device 302 to the selected directory listing 220 by interfacing with the directory assist and connect module 110 and actuating a pushbutton of the remote control device 330, by voice commands, and/or by other selection methods. According to some of the embodiments, the directory assist and connect module 110 presents a graphical user interface that enables a broad range of functionality for accessing, searching, selecting, and/or distributing a communications address of the selected directory listing 220 and for establishing the communications link with the selected directory listing 210. For example, an infrared remote control and/or an optional wireless keyboard (or another communications device) can communicate with the media delivery device 302 to interact with the graphical user interface that is presented on an audio/visual device such as a TV screen. The graphical user interface may be used to access one or more electronic communications directories, associated broadcast and on-demand video and audio content, and associated multimedia applications and services, and thereafter, to select the directory listing 220 and initiate the communications link. When the directory assist and connect module 110 initiates the communications link, a communications signal having the communications address of the selected directory listing 220 is routed via the communications network 210.

According to some further embodiments, the media delivery device 302 may select a second directory listing and add in the second directory listing with the communications link among the selected directory listing 220 and the media delivery device 302. And in some further embodiments, the directory assist and connect module 110 may select the directory listing and the selected directory listing and simultaneously establish the communication connection among the media delivery device 302, the selected directory listing 220, and the second directory listing. Still further embodiments provide that the directory assist and connect module 110 (or alternatively the broadcast source) may insert an audio/visual cue into the electronic communications directory to prompt the user for a response during presentment of the selected directory listing or during establishment of the communications connection. If the user responds to the audio/visual cue, then the response may be stored to the media delivery device 302 and/or communicated via the communications network to an external network (not shown). If, however, the user does not respond to the audio/visual cue, then presentment of the cue discontinues.

FIG. 5 illustrates another directory assist and connect operating environment 500. As shown in FIG. 5, the media delivery device 302 can link in a wide range of communications devices 510 to the communications connection. The communications device 510 may include a cellular phone 511, an interactive pager 512, a personal digital assistant (PDA), a Voice over Internet Telephony (VoIP) phone 514, a computer system 515, a global positioning system (GPS) 516, a control panel integrated into a piece of furniture such as a couch, chair, or table 517, and any device having a digital signal processor (DSP) 518. For example, the media delivery device 302 may link in an appliance, a watch, a radio, vehicle electronics, a clock, a printer, a gateway, and/or another apparatus and system. And, because the communications device 510 may have limited communications capabilities (e.g., lack of a display and/or limited graphical capabilities), the media delivery device 302 is available to participate in the communications connection of the communications device 510 and the selected directory listing 220 so that the user has the presentation and communications advantages of the media delivery device 100.

FIG. 6 illustrates another directory assist and connect operating environment 600 similar to the directory assist and connect operating environment 500 of FIG. 5. In FIG. 5, the directory assist and connect module 100 establishes a communications connection with the communications address of the selected directory listing and links in the communications device 510. For example, the cellular phone 511 communicates with a wireless transceiver of the media delivery device 100 such that the user may use the cellular phone (or the media delivery device 100) to communicate with the selected communications address 220. However, FIG. 6 illustrates an alternate embodiment. Here, the directory assist and connect module 100 communicates the communications address of the selected directory listing to the communications device 510 and then the communications device 510 establishes the communications connection with the selected directory listing 220. For example, the media delivery device 100 communicates a telephone number of the POTS phone 427 to the cellular phone 511, and the cellular phone establishes the communications connection with the POTS phone 427 via the cellular service provider's communications network and/or a telecommunications network serving the POTS phone 427.

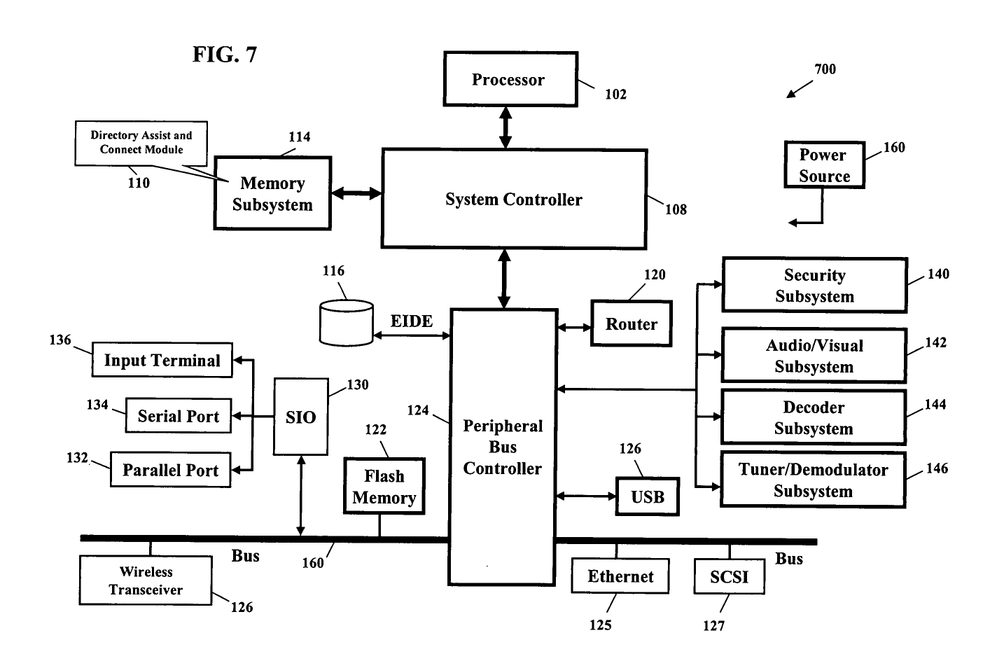

FIG. 7 depicts another block diagram of the directory assist and connect module 110 residing in an alternate computer system shown as media delivery device 700. As FIG. 7 shows, the directory assist and connect module 110 operates within a system memory device. The directory assist and connect module 110, for example, is shown residing in a memory subsystem 114. The directory assist and connect module 110, however, could also reside in flash memory 122 or the peripheral storage device 116. The media delivery device 700 also has one or more central processors 102 executing an operating system. The operating system has a set of instructions that control the internal functions of the media delivery device 700. The system controller 108 provides a bridging function between the one or more central processors 102, a security subsystem 140, an audio/visual subsystem 142, a decoder subsystem 144, a tuner/demodulator subsystem 146, the memory subsystem 114, the peripheral storage device 116, a router 120, flash memory 122, and with other components such as input/output devices communicating with a PCI (Peripheral Controller Interface) bus 160. The PCI bus 160 is controlled by a Peripheral Bus Controller 124. The Peripheral Bus Controller 124 (a “Southbridge”) is an integrated circuit that serves as an input/output hub for various peripheral ports and/or transceivers. The above-identified peripheral ports allow the media delivery device 700 to communicate with a variety of devices through networking ports (such as SCSI 127 or Ethernet 126) and/or transceivers that include Wireless Communications (“Comm”) Device Transceiver 126 (for communication of any frequency signal in the electromagnetic spectrum, such as, for example, Wireless 802.11 and Infrared) and wired communications ports/connections (such as modem V90+ and compact flash slots). These peripheral ports also include other networking ports, such as, a parallel port 132 and/or a serial port 134. Still further, the media delivery device 700 includes a power source 160, such as, for example, a rechargeable battery to provide power and allow the media delivery device 700 to be portable. Again, those of ordinary skill in the art understand that the program, processes, methods, and systems described in this patent are not limited to any particular computer system or computer hardware.

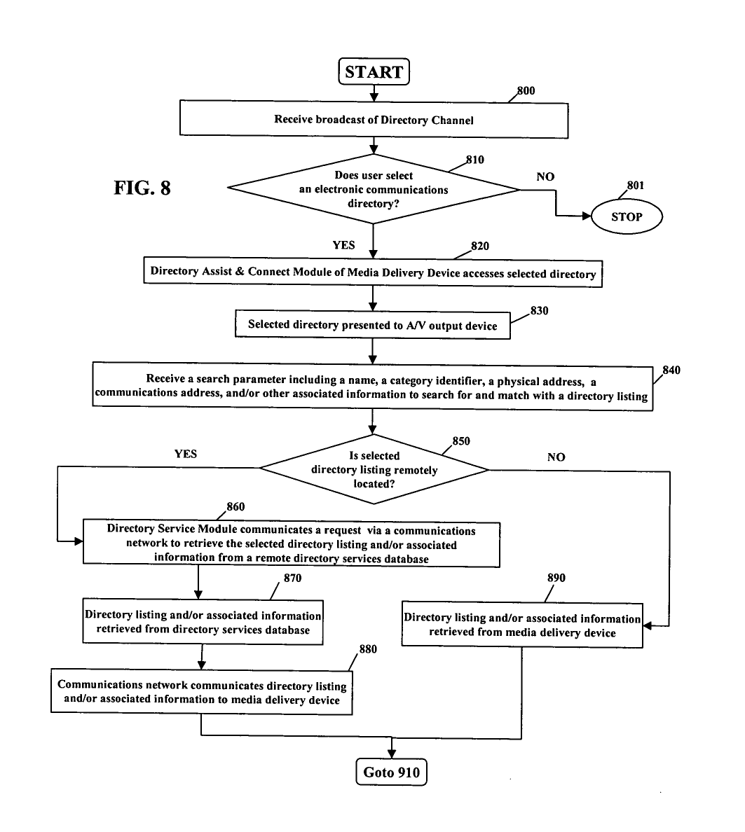

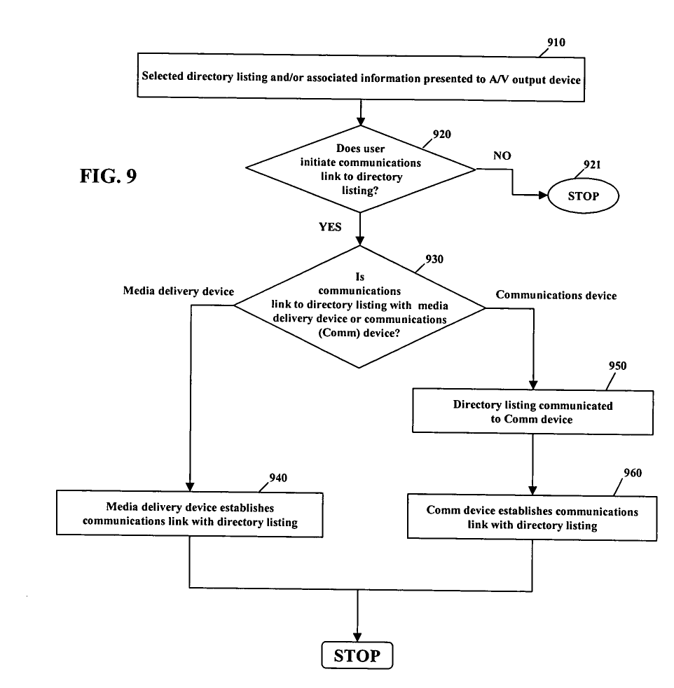

FIGS. 8-9 are flowcharts showing exemplary processes of providing directory services. A directory service provider broadcasts or otherwise communicates a directory channel to a media delivery device via a communications network [block 800]. Thereafter a user may select an electronic communications directory to access, create, modify, forward to a communications device or another media delivery device, and/or otherwise manage. If the user does not select the directory, then the process stops [block 801]. Otherwise, if the user selects the directory, then a computer program product referred to as a directory assist and connect module accesses the selected directory [block 810]. For example, if the user selects a Yellow Pages directory for a particular geographic area (e.g., Richmond, Va.), then the directory assist and connect module accesses the selected Yellow Pages provided by a service provider. The selected directory is presented to an audio/visual subsystem of the media delivery device so that the user sees and/or hears the directory information [block 830]. Thereafter, the user may input a search parameter, such as, for example, a name of an individual and/or a business, a listing of a category and/or services, a physical address, a telecommunications address (e.g., a telephone number), an electronic communications address (e.g., an email address), and/or other associated information (e.g., personalized information of an individual such as a birthday, helpful information for a business such as hours of operation, acceptable means of payment, a map within a proximate area of the listed business address, and incentives and/or other promotional material, and/or helpful information for a club and/or organization such as a calling tree for passing messages, identification of officers with responsibilities, and other helpful information) [block 840]. The directory assist and connect module searches the directory for a matching directory listing and then determines if the matching directory listing is remotely stored and/or locally stored [block 850]. If the selected directory listing is remotely stored, then the method continues with the directory assist and connect module communicating a request to the remote directory services database to retrieve the selected directory listing, associated information, and/or the directory [block 860]. The selected directory listing, associated information, and/or the directory is retrieved [block 870] and communicated to the media delivery device via the communications network [block 880]. If, however, the selected directory listing is locally stored, then the method continues with the directory assist and connect module retrieving the selected directory listing from the media delivery device (and/or a local database coupled thereto) [block 890].

As shown in FIG. 9, the method then continues with a presentation of the selected directory listing and/or associated information to the AV output device [block 910]. The user may then view and/or hear the selected directory listing and/or the associated information. Next, the directory assist and connect module determines if the user wishes to establish a communications session with the selected directory listing [block 920]. If the user does not wish to establish the communications connection, then the method stops [block 921]. If, however, the user wishes to establish the communications connection, then the directory assist and connect module determines if the communications link to a communications address of the selected directory listing is with the media delivery device or with an alternate communications device (e.g., a cellular phone) [block 930]. If the communications link is with the media delivery device, then the directory assist and connect module initiates the communications connection with the media delivery device [block 840]. Alternatively, if the communications link is with an alternate communications device, then the directory assist and connect module communicates the communications address of the directory listing to the communications device [block 950] and the communications device establishes the communications link with the selected directory listing [block 960]. Alternatively, the media deliver device may establish the communications connection with the selected communications address and link in another communications device (via the media delivery device). While the processes in FIGS. 8-9 are shown in series, these processes may occur in different orders and/or at simultaneous times as one of ordinary skill in the art will understand.

While several exemplary implementations of embodiments of this invention are described herein, various modifications and alternate embodiments will occur to those of ordinary skill in the art. Accordingly, this invention is intended to include those other variations, modifications, and alternate embodiments that adhere to the spirit and scope of this invention.

What is claimed is:

1. A media delivery device, comprising:
an electronic communications directory having a directory listing of a directory name with a communications address, the directory name further associated with at least one of an identification category and a physical address; and
a directory assist and connect module for accessing and selecting directory content of the electronic communications directory and for initiating a communications signal to establish a communications connection with the communications address of the selected directory listing.

2. The apparatus of claim 1, further comprising:
a wireless transceiver for transmitting and receiving communications signals to and from a wireless device.

3. The apparatus of claim 2, the wireless device comprising a remote control device for remotely interfacing with the media delivery device.

4. The apparatus of claim 2, the wireless device comprising an input terminal integrated into a piece of furniture for remotely interfacing with the media delivery device.

5. The apparatus of claim 2, the wireless device comprising a wireless communications device for initiating an outgoing communication to the communications address.

6. The apparatus of claim 4, wherein the wireless communications device comprises at least one of:
a mobile phone,
a cellular phone,
a WAP phone,
a satellite phone
a computer,
a modem,
a pager,
a personal digital assistant,
an interactive television,
a digital signal processor,
an appliance, and
a Global Positioning System device.

7. The apparatus of claim 1, further comprising:
an input terminal for inputting information to the directory assist and connect module.

8. The apparatus of claim 1, further comprising:
a communications interface for initiating an alternate outgoing communication signal to the communications address.

9. The apparatus of claim 1, wherein the directory listing comprises at least one of a yellow pages directory listing, a white pages directory listing, and an electronic mail directory.

10. A method, comprising the steps of:
accessing an electronic communications directory of a media delivery device, the electronic communications directory having a directory listing of at least one directory name with a communications address, the directory name further associated with at least one of an identification category and a physical address;
selecting a directory listing; and
initiating a communications signal to establish a communications connection with the communications address of the selected directory listing.

11. The method of claim 10, wherein the step of initiating the communications signal to establish the communications connection with the communications address of the selected directory listing comprises communicating the communications address of a selected directory listing from the media delivery device to a communications device, the communications device establishing the communications connection with the communications address of the selected directory listing.

12. The method of claim 11, wherein the communications device comprises at least one of:
a telephone,
a mobile phone,
a cellular phone,
a WAP phone,
a satellite phone
a computer,
a modem,
a pager,
a personal digital assistant,
an interactive television,
an appliance,
a communications device integrated into a piece of furniture,
a digital signal processor, and
a Global Positioning System device.

13. The method of claim 10, further comprising the step of:
storing the selected directory listing in the communications device.

14. The method of claim 10, further comprising the steps of:
selecting a second directory listing; and
initiating the communications signal to establish the communications connection with the communications address of the selected directory listing and with the second directory listing.

15. The method of claim 10, further comprising the steps of:
inserting an audio/visual cue into the electronic communications directory for prompting a user for a response during presentation of the selected directory listing; and
if the user responds to the audio/visual cue, then communicating the indicated response to an external network.

16. The method of claim 15, further comprising the step of:
if the user does not respond to the audio/visual cue, then discontinuing presentation of the cue with the selected directory listing and continuing presentation of at least one of the selected directory listing and the electronic communications directory without a subsequent audio/visual cue.

17. The method of claim 15, wherein the audio/visual cue comprises an interactive advertisement.

18. The method of claim 10, wherein the directory listing comprises at least one of a yellow pages directory listing, a white pages directory listing, and an electronic mail directory.

19. The method of claim 10, further comprising the step of:
monitoring selections of the directory listing, collecting information associated with the selections, and transmitting the collected information to an external network.

20. A storage medium on which is encoded instructions for performing the following steps of:
accessing an electronic communications directory of a media delivery device, the electronic communications directory having a directory listing of at least one directory name with a communications address, the directory name further associated with at least one of an identification category and a physical address;
selecting a directory listing; and
initiating a communications signal to establish a communications connection with the communications address of the selected directory listing.

21. The storage medium of claim 20, further comprising instructions for performing the steps of:
inserting an audio/visual cue into the electronic communications directory for prompting a user for a response during presentation of the selected directory listing; and
if the user responds to the audio/visual cue, then communicating the indicated response to an external network.

22. The storage medium of claim 20, further comprising instructions for performing the steps of:
monitoring selections of the directory listings, collecting information associated with the selections, and transmitting the collected information to an external network.
